(19) United States
(12) Patent Application Publication
(10) Pub. No.: US 2019/0184471 A1
(43) Pub. Date: Jun. 20, 2019

(54) CUTTER FASTENING APPARATUS

(71) Applicant: Ching-Ting CHEN, Taichung City (TW)

(72) Inventor: Ching-Ting CHEN, Taichung City (TW)

(21) Appl. No.: 15/847,903

(22) Filed: Dec. 19, 2017

(51) Int. Cl. B23B 31/20; B23B 51/12

(52) U.S. Cl. CPC B23B 31/20; B23B 2231/2089; B23B 51/123

(57) ABSTRACT

A cutter fastening apparatus has a body, a collet, a cutter, and a cap. The body has an outer thread. The collet is mounted in the body and has an abutting groove formed in an outer surface of the collet and a through hole formed through a front surface of the collet. The cutter is mounted through and fixed to the through hole of the collet. The cap is screwed with the outer thread of the body and has a driving ring portion protruding from an inner surface of the cap and a balance groove formed in the inner surface of the cap and being adjacent to the driving ring portion. The cap has a clamping portion protruding from the inner surface of the cap and a holding portion protruding from the inner surface of the cap.

### BACKGROUND OF THE INVENTION

### 1. Field of the Invention

The invention relates to a cutter fastening apparatus, and more particularly, a cutter fastening apparatus that enables a cutter to be easily detached from the body and the collet.

### 2. Description of Related Art

A conventional cutter fastening apparatus comprises a body, a collet, a cutter, and a cap. The body has a front end, an installing hole, and an outer thread. The installing hole is formed through the front end of the body. The outer thread is formed around the front end of the body. The collet is mounted in the installing hole and has a front surface and a through hole, and the through hole is formed through the front surface of the collect. The cutter is mounted through the through hole of the collet. The cap is threaded with the outer thread of the body. The cap has a driving ring portion protruding from an inner surface of the cap. The driving ring portion contacts an outer surface of the collet, and this makes the cap detachable from the collet via the driving ring portion when the cap is detached from the body. Accordingly, the cutter fastening apparatus is easy to be detached.

However, when the conventional fastening apparatus is in use, the cutter would rotate at a high speed and the cap has the driving ring portion, and this makes the moment of inertia of the cutter unbalanced. The cutter would vibrate during rotation to negatively influence the accuracy of the cutter in the operating process.

To overcome the shortcomings of the conventional cutter fastening apparatus, the present invention provides a cutter fastening apparatus to mitigate or obviate the aforementioned problems.

### SUMMARY OF THE INVENTION

The main objective of the present invention is to provide a cutter fastening apparatus that enables the cutter to be easily detached from the body and the collect.

The cutter fastening apparatus has a body, a collet, a cutter, and a cap. The body has an outer thread. The collet is mounted in the body and has an abutting groove formed in an outer surface of the collet and a through hole formed through a front surface of the collet. The cutter is mounted through and fixed to the through hole of the collet. The cap is screwed with the outer thread of the body and has a driving ring portion protruding from an inner surface of the cap and a balance groove formed in the inner surface of the cap and being adjacent to the driving ring portion. The cap has a clamping portion protruding from the inner surface of the cap and a holding portion protruding from the inner surface of the cap.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a cutter fastening apparatus in accordance with the present invention;

FIG. 2 is an exploded perspective view of the cutter fastening apparatus in FIG. 1;

FIG. 3 is a cross sectional side view of the cutter fastening apparatus in FIG. 1;

FIG. 4 is an enlarged perspective view in partial section of the cap of the cutter fastening apparatus in FIG. 1;

FIG. 5 is a cross sectional side view of the cap in FIG. 4;

FIG. 6 is a cross sectional front view of the cap along line 6-6 in FIG. 5;

FIG. 6A is an enlarged cross sectional front view of the cap in FIG. 6;

FIG. 7 is another enlarged cross sectional front view of the cap in FIG. 6.

### DETAILED DESCRIPTION OF PREFERRED EMBODIMENT

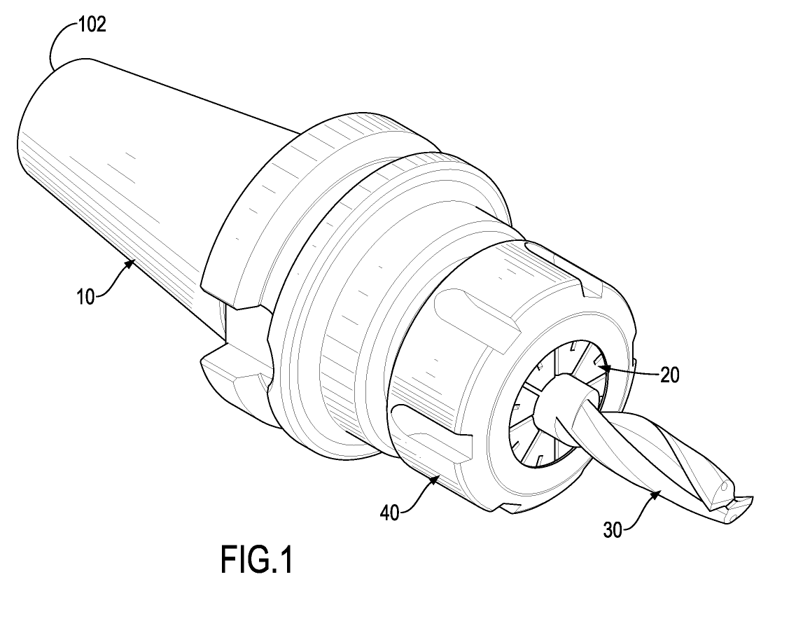

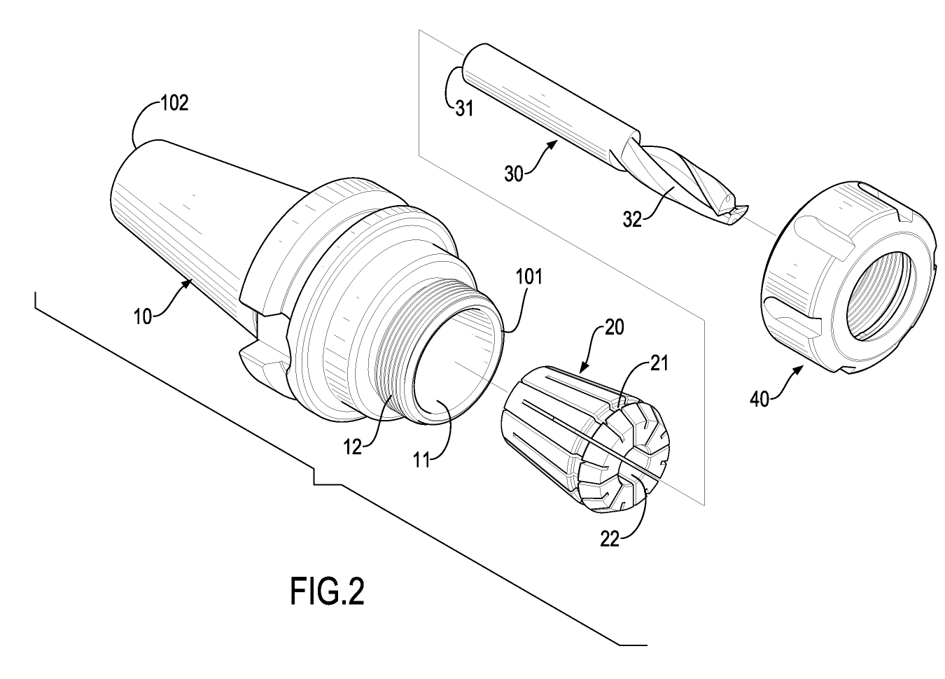

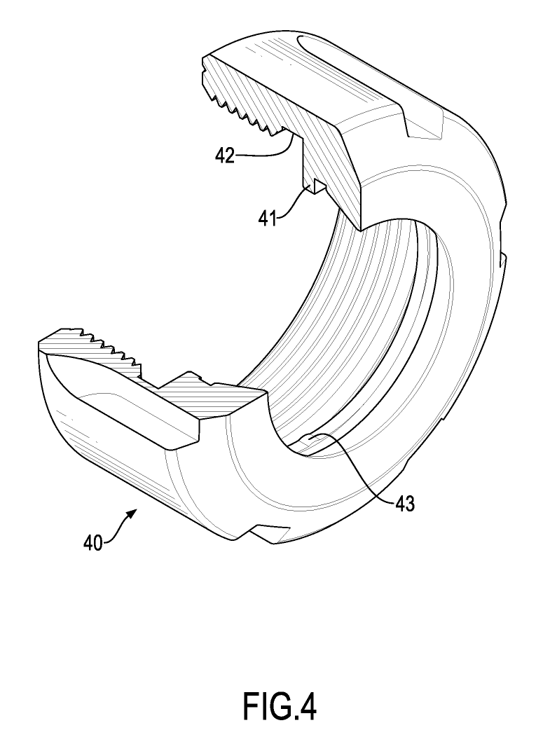

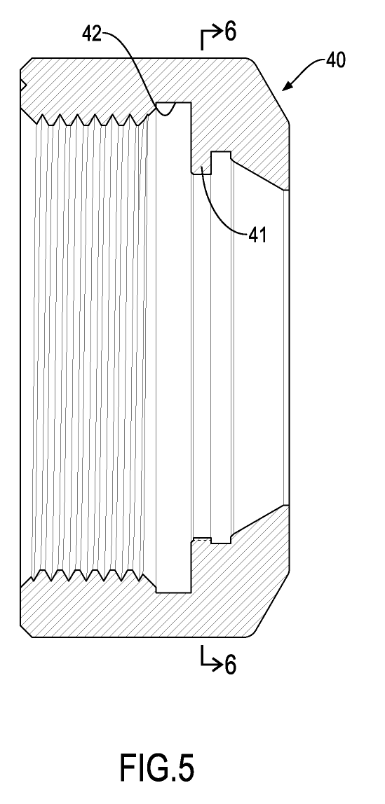

With reference to FIGS. 1 to 5, a cutter fastening apparatus in accordance with the present invention comprises a body 10, a collet 20, a cutter 30, and a cap 40.

The body 10 has a front end 101, a rear end 102, an installing hole 11, and an outer thread 12. The installing hole 11 is formed through the front end 101 of the body 10. The outer thread 12 is formed in an outer surface of the front end 101 of the body 10. The collet 20 is connected to and fixed at the installing hole 11 of the body 10. The collet 20 has an annular abutting groove 21 and a through hole 22. The abutting groove 21 is formed in an outer surface of the collet 20. The through hole 22 is formed through a front surface of the collet 20. The cutter 30 is mounted through and fixed to the through hole 22 of the collet 20. The cutter 30 has a mounting end 31 and a sharp end 32. The mounting end 31 of the cutter 30 is a smooth rod and is mounted through and fixed to the through hole 22 of the collet 20. The sharp end 32 of the cutter 30 is a sharp knife body and extends out of the through hole 22 of the collet 20.

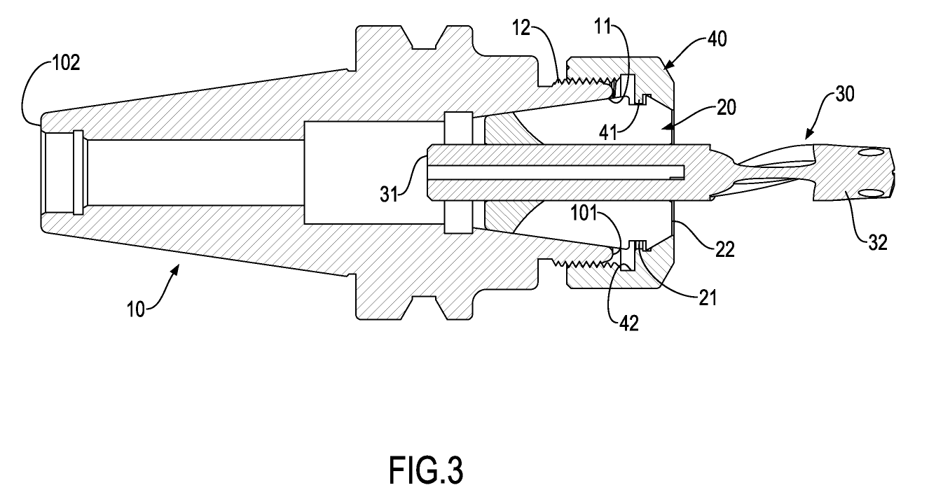

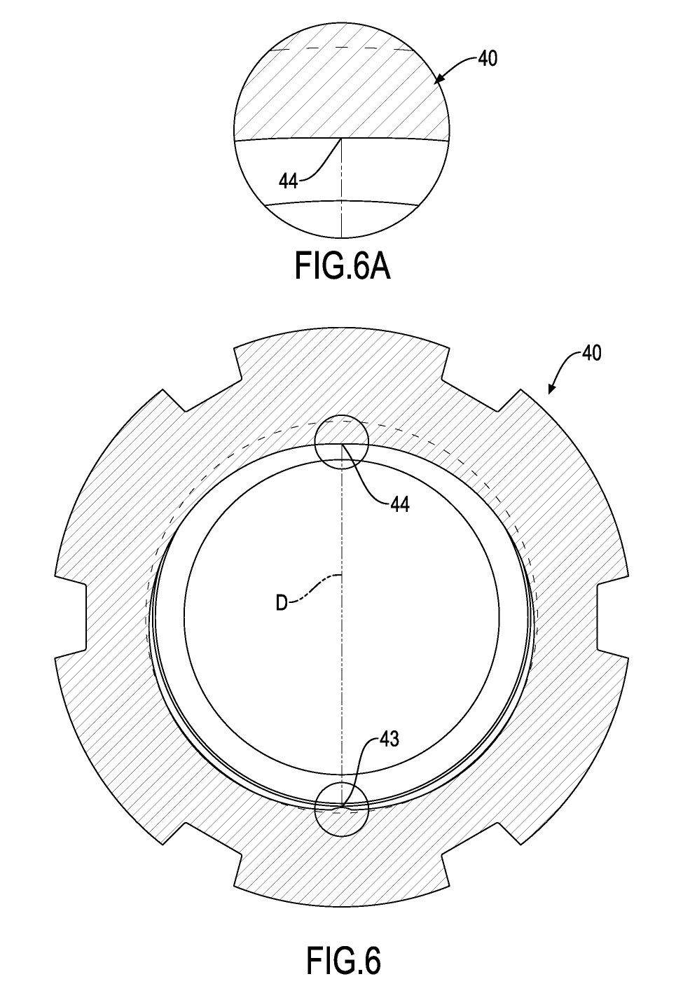

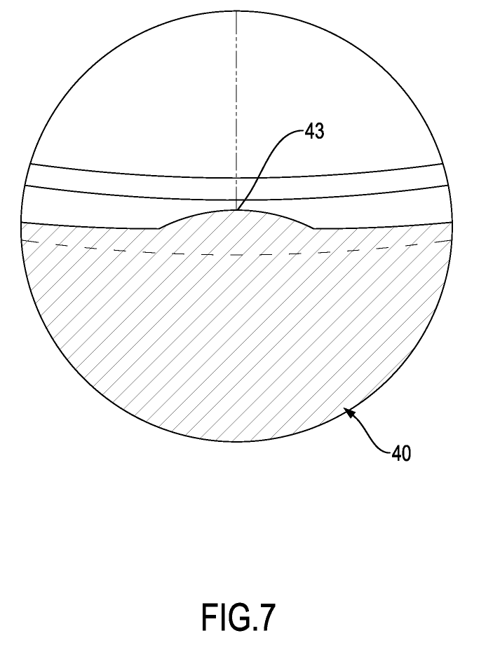

With further reference to FIG. 3, the cap 40 is screwed with the outer thread 12 of the body 10. The cap 40 has a driving ring portion 41, a balance groove 42, a clamping portion 43, and a holding portion 44. The driving ring portion 41 protrudes from an inner surface of the cap 40. The driving ring portion partly extends into the abutting groove 21 of the collet 20. The balance groove 42 is formed in the inner surface of the cap 40 and is adjacent to the driving ring portion 41. When the cutter fastening apparatus in accordance with the present invention is rotating, the balance groove 42 and the driving ring portion 41 achieve a dynamic balance effect. Furthermore, with reference to FIGS. 6 and 7, the clamping portion 43 and the holding portion 44 protrude from the inner surface of the cap 40. The clamping portion 43 and the holding portion 44 are disposed on the inner surface of the cap 40 at a spaced interval. Preferably, the clamping portion 43 and the holding portion 44 are disposed along a diametrical line (D) of the inner surface of the cap 40.

When the cutter fastening apparatus in accordance with the present invention is in use, since the balance groove 42 is formed in the inner surface of the cap 40, the moment of inertia of the driving ring portion 41 and the moment of inertia of the balance groove 42 can be balanced. When the cutter fastening apparatus in accordance with the present invention is rotating, the cap 40 can rotate stably and can be kept from vibrating. Furthermore, with reference to FIG. 6, since the clamping portion 43 and the holding portion 44 protrude from the inner surface of the cap 40, in the procedure of detaching the cap 40 from the body 10, the clamping portion 43 and the holding portion 44 can hold and abut the collet 20 to prevent the collet 20 from falling to the ground.

The cutter fastening apparatus in accordance with the present invention has the balance groove 42, so the driving ring portion 41 and the balance groove 42 can achieve moment balance. Furthermore, the design of the clamping portion 43 and the holding portion 44 can prevent the collet 20 from falling to the ground when the collect 20 is being detached from the body 10.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A cutter fastening apparatus comprising:
a body having:
a front end;
a rear end;
an installing hole formed through the front end of the body; and
an outer thread formed in an outer surface of the front end of the body;
a collet mounted through and fixed to the installing hole of the body and having
an abutting groove formed in an outer surface of the collet;
a through hole formed through a front surface of the collet;
a cutter mounted through and fixed to the through hole of the collet;
a cap screwed with the outer thread of the body and having
a ring portion protruding from an inner surface of the cap;
a groove formed in the inner surface of the cap and being adjacent to the driving ring portion;
a first protrusion protruding from an inner surface of the ring portion; and
a second protrusion protruding from the inner surface of the ring portion, wherein the first protrusion and the second protrusion are disposed on the inner surface of the ring portion, are spaced at an interval from each other, and hold and abut the collet.

2. The cutter fastening apparatus as claimed in claim 1, wherein the first protrusion and the second protrusion are disposed along a diametrical line of the inner surface of the cap.
